(19) United States
(12) Patent Application Publication
(10) Pub. No.: US 2016/0229042 A1
(43) Pub. Date: Aug. 11, 2016

(54) BARREL TYPE RATCHET WRENCH WITH A SNAP-IN STRUCTURE

(71) Applicant: Jun-Tsai Shyu, Taichung (TW)

(72) Inventor: Jun-Tsai Shyu, Taichung (TW)

(21) Appl. No.: 14/615,401

(22) Filed: Feb. 5, 2015

(51) Int. Cl. B25B 23/00; B25B 13/46

(52) U.S. Cl. CPC B25B 23/0035; B25B 13/462

(57) ABSTRACT

A barrel type ratchet wrench with a snap-in structure including a wrench body having a ratchet acting head with a shallow groove adjacent to a hollow barrel. Moreover, a positioning bolt hole and a guide slot are positioned within the shallow groove. The positioning bolt hole is provided for receiving a direction switching lever and a positioning bolt of the ratchet module. A fixing plate and a snap plate are positioned under the direction switching lever. The lock plate has an external shape similar to the profile of the shallow groove and includes a snap portion, a long hole, a pushing portion and a bottom guide projection. The bottom guide projection and an elastic element are firmly positioned in the guide slot of the wrench body in such a way that the bottom guide projection of the engaging piece is constantly biased by the elastic element. The lock plate is fixed by screwing two screwing elements into corresponding screw holes of the wrench body. the snap portion of the engaging piece projects into the hollow barrel of the ratchet acting head. By means of the combination of the above-mentioned components, the snap portion can firmly snap into a corresponding annular groove of an external socket or an external bit. In this way, an unexpected disengagement is avoided.

### BACKGROUND OF THE INVENTION

1. Fields of the Invention

The present invention relates to a barrel type ratchet wrench with a snap-in structure, and more particularly to the snap-in structure capable of latching an external socket with an external adapter to prevent them from falling out unexpectedly or affecting the normal smooth operation of the wrench.

2. Description of the Related Art

The ratchet wrench refers to a professional wrench having a ratchet direction controlling mechanism for controlling the driving direction to apply a force, and barrel type ratchet wrench refers to a wrench having a ratchet acting head designed as a hollow barrel provided for plugging a component module such as an external socket or an external adapter and controlling the rotation direction of a screw (not shown in the figure).

Although the conventional barrel type ratchet wrench has been used for years and common to users, yet the connection between the external socket and the external adapter with the hollow barrel is simply by abutting a top bead (installed on a side of the external socket and the external adapter) or latching a ring (installed at an inner periphery of the hollow barrel), so that the two produce a combining strength of a certain level and will not be separated easily. As we all know, the wrench probably hits a surrounding object or the operator moves too much in the process of applying a force for the operation of the wrench, so that the external socket and the external adapter may be separated from the hollow barrel easily, and the operation or construction may be affected adversely, or the external socket and external adapter may even be lost or missing, and thus resulting gin an unexpected difficult situation. Obviously, the conventional design requires further improvements.

### SUMMARY OF THE INVENTION

It is a primary object of the present invention to prevent the external socket and the external adapter from being separated from the wrench unexpectedly, so as to achieve the effects of maintaining a smooth operation of the construction effectively, preventing unnecessary losses caused by any unsmooth operation, and enhancing the practicality of the wrench to overcome the aforementioned problems.

According to the invention, a barrel type ratchet wrench with a snap-in structure includes a wrench body having a ratchet acting head with a shallow groove adjacent to a hollow barrel. Moreover, a positioning bolt hole and a guide slot are positioned within the shallow groove. The positioning bolt hole is provided for receiving a direction switching lever and a positioning bolt of the ratchet module. A fixing plate and a snap plate are positioned under the direction switching lever. The lock plate has an external shape similar to the profile of the shallow groove and includes a snap portion, a long hole, a pushing portion and a bottom guide projection. The bottom guide projection and an elastic element are firmly positioned in the guide slot of the wrench body in such a way that the bottom guide projection of the engaging piece is constantly biased by the elastic element. The lock plate is fixed by screwing two screwing elements into corresponding screw holes of the wrench body. the snap portion of the engaging piece projects into the hollow barrel of the ratchet acting head. By means of the combination of the above-mentioned components, the snap portion can firmly snap into a corresponding annular groove of an external socket or an external bit. In this way, an unexpected disengagement is avoided.

### BRIEF DESCRIPTION OF THE DRAWINGS

The accomplishment of this and other objects of the invention will become apparent from the following description and its accompanying drawings of which:

FIG. 1 is an exploded perspective view of a preferred embodiment of the present invention;

FIG. 2 is a perspective view of the assembly as depicted in FIG. 1;

FIG. 3 is a top view of FIG. 2 (before mounting the external socket); and

FIG. 4 is a schematic view of the operation of the invention as depicted in FIG. 3 (before mounting the external socket).

### DETAILED DESCRIPTION OF THE PREFERRED EMBODIMENT

The present invention will now be described in more detail hereinafter with reference to the accompanying drawings that show various embodiments of the invention.

The present invention is an improved invention of prior application Ser. No. 14/195,818.

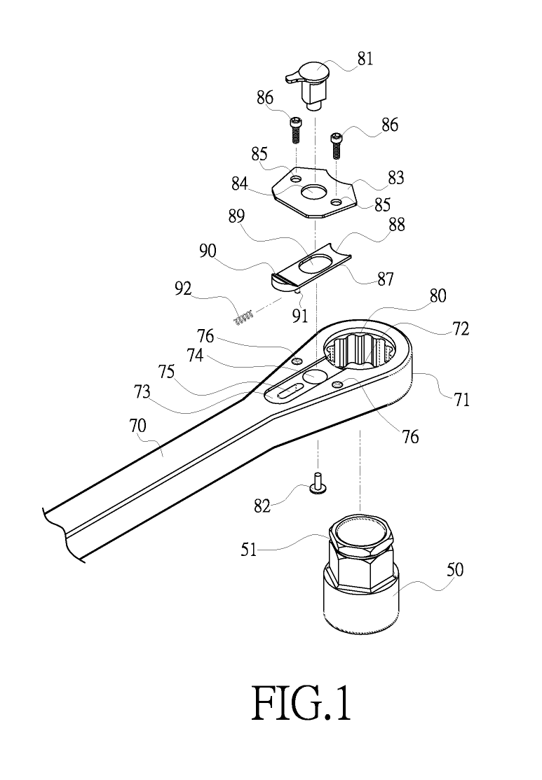

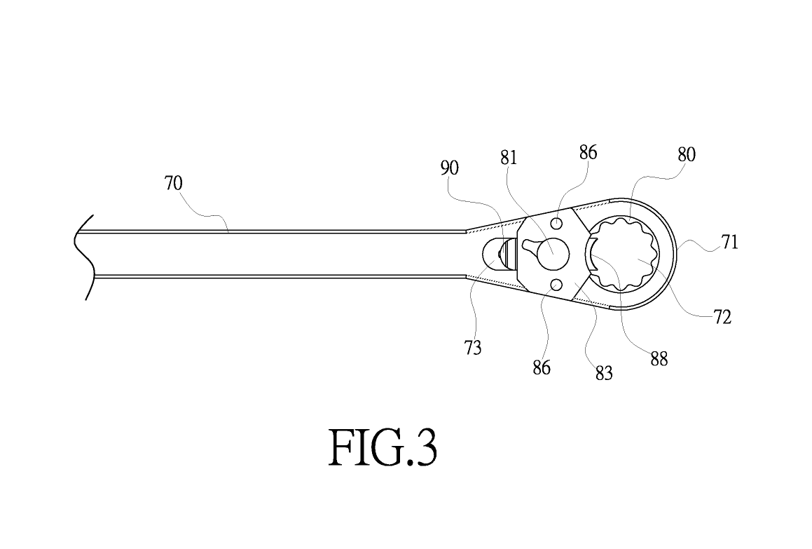

With reference to FIGS. 1 to 3 for a preferred embodiment of the present invention, the ratchet wrench comprises a wrench body 70, a fixing plate 83 and a snap plate 87.

The wrench body 70 has a ratchet acting head 71 with a ratchet module 80 disposed at an end of the wrench body 70. A hollow barrel 72 is positioned in the ratchet acting head 71. A shallow groove 73 is formed on a side adjacent to the hollow barrel 72 and has a positioning bolt hole 74 and a guide slot 75. The positioning bolt hole 74 is provided for plugging a direction switching lever 81 and a positioning bolt 82 of the ratchet module 80.

The fixing plate 83 is positioned under the direction switching lever 81 and includes a central through hole 84 and two positioning holes 85. Two screwing elements 86 are screwed through the positioning holes 85 into corresponding screw holes 76 for locking the snap plate 87 in place.

The snap plate 87 with an external shape similar to the profile of the shallow groove 73 is positioned under the direction switching lever 81 and disposed horizontally in the shallow groove 73. The snap plate 87 includes a snap portion 88, a long hole 89, a pushing portion 90 and a bottom guide projection 91. The bottom guide projection 91 and an elastic element 92 are positioned in the guide slot 75 of the wrench body 70 in such a way that the bottom guide projection 91 of the engaging piece 87 is constantly biased by the elastic element 92.

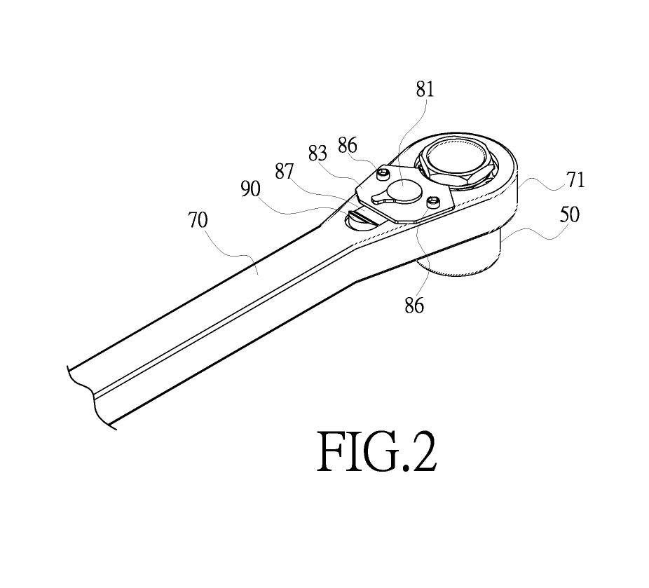

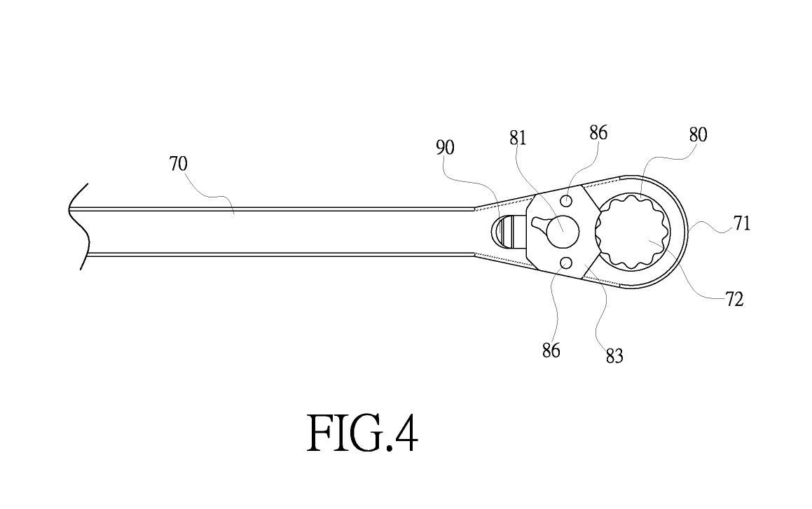

As shown in FIGS. 2 through 4, the snap portion 88 of the engaging piece 87 projects into the hollow barrel 72 of the ratchet acting head 71. After an external socket 50 is inserted into the hollow barrel 72, the snap portion 88 can firmly snap into a corresponding annular groove 51 of the external socket 50. In this way, an unexpected disengagement is avoided. In removing the external socket 50, it is only needed to push the pushing portion 90 of the engaging piece 87 in a reverse direction (see FIG. 4) for disengaging the snap portion 88 of the engaging piece 87 from the annular groove 51 of the external socket 50. In this way, an easy removal and replacement is ensured. Moreover, the movement of the engaging piece 87 won't affect the control/operation of the direction switching lever 81 of the ratchet module 80.

The ratchet module 80, the direction switching lever 81 and the positioning bolt 82 belong to the prior art and are not objects of the invention so that no further description thereto is given hereinafter.

Many changes and modifications in the above-described embodiments of the invention can, of course, be carried out without departing from the scope thereof. Accordingly, to promote the progress in science and the useful arts, the invention is disclosed and is intended to be limited only by the scope of the appended claims.

What is claimed is:

1. A barrel type ratchet wrench with a snap-in structure, comprising:
a wrench body having a ratchet acting head with a ratchet module disposed at an end of the wrench body, a hollow barrel being positioned in the ratchet acting head, a shallow groove being formed on a side adjacent to the hollow barrel and having a positioning bolt hole and a guide slot, the positioning bolt hole being provided for receiving a direction switching lever and a positioning bolt of the ratchet module;
a fixing plate positioned under the direction switching lever and having a central through hole and two positioning holes, two screwing elements being screwed through the positioning holes into corresponding screw holes for locking an engaging piece in place; and
a snap plate having an external shape similar to the profile of the shallow groove and positioned under the direction switching lever, the snap plate being disposed horizontally in the shallow groove, the snap plate having a snap portion, a long hole, a pushing portion and a bottom guide projection, the bottom guide projection and an elastic element being firmly positioned in the guide slot of the wrench body in such a way that the bottom guide projection of the engaging piece is constantly biased by the elastic element.
